(19) United States
(12) Patent Application Publication
(10) Pub. No.: US 2026/0023347 A1
(43) Pub. Date: Jan. 22, 2026

(54) EXTERNAL PART FOR HOROLOGY, JEWELLERY OR FASHION ACCESSORIES COMPRISING TITANIUM OXIDE LAYERS

(71) Applicant: Rubattel & Weyermann S.A., La Chaux-de-Fonds (CH)

(72) Inventors: Giovanni POLY, Maiche (FR); Frédéric JEANRENAUD, La Chaux-de-Fonds (CH)

(73) Assignee: Rubattel & Weyermann S.A., La Chaux-de-Fonds (CH)

(21) Appl. No.: 19/248,824

(22) Filed: Jun. 25, 2025

(30) Foreign Application Priority Data
Jul. 17, 2024 (EP) 24189228.0

(51) Int. Cl. G04B 45/00; A44C 27/00; C25D 11/26; G04D 3/00

(52) U.S. Cl. CPC G04B 45/0076; A44C 27/00; G04D 3/0002; G04D 3/0069; G04D 3/0074; C25D 11/26

(57) ABSTRACT

A method for decorating an external part (10) for horology, jewellery or fashion accessories, including the steps of: forming a first interference (110) layer of titanium oxide over the entire decorative face (101) of a titanium substrate (100) by anodising the decorative face (101) at a voltage V1; machining a portion of the first interference layer (110) so as to form at least one opening (111) leading to a portion of the decorative face (101); and forming a second interference layer (120) of titanium oxide by anodising the portion at a voltage V2 lower than voltage V1.

### CROSS-REFERENCE TO RELATED APPLICATIONS

This application claims priority to European Patent Application No. 24189228.0 filed on Jul. 17, 2024, the entire contents of which are incorporated herein by reference.

### TECHNICAL FIELD OF THE INVENTION

The invention relates to the field of timepieces, jewellery or fashion accessories.

More specifically, the invention relates to a method for decorating an external part. This method can be advantageously applied to any external part in the field of horology, jewellery, fashion accessories, such as leather goods, eyeglasses, writing instruments or portable electronic apparatuses.

More specifically, in the field of horology, an external part can consist of a dial, a plate, a bar, a train, an oscillating mass, a bezel, a middle, a link or other part of a wristlet or any other visible component of a watch.

### Technological Background

In the fields of horology, jewellery and fashion accessories, market players are constantly on the lookout for new decorative solutions to change the appearance of their products in order to enhance product appeal or to stand out from the competition.

For example, external parts are commonly coloured by spraying them with a varnish, particularly in the field of horology. However, these varnishes mask any decorations that may have been created by surface structuring, such as sunray brushing.

Thin-film vacuum deposition methods are also used to colour external parts. However, such deposition methods have the drawback of homogenously colouring the external part and therefore limit the decorative possibilities or make them more complex to use. Moreover, these deposition methods are relatively expensive.

The invention addresses the need to colour an external part with several colours without the drawbacks mentioned above.

### SUMMARY OF THE INVENTION

The invention achieves the aforementioned objective and, to this end, relates to a method for decorating an external part for horology, jewellery or fashion accessories, comprising the steps of:
forming a first interference layer of titanium oxide over the entire decorative face of a titanium substrate by anodising said decorative face at a voltage V1,
machining a portion of the first interference layer so as to form at least one opening leading to a portion of the decorative face,
forming a second interference layer of titanium oxide by anodising said portion at a voltage V2 lower than voltage V1.

One of the advantages of the present invention is to preserve the appearance of the physical features on the decorative face of the body of the external part. In other words, any decorations created by surface structuring on the decorative face of the body of the external part remain visible due to the minimal thickness of the thin decorative layer.

The present invention also makes it possible to colour an external part without adding a colouring agent.

Moreover, the present invention makes it possible to colour the external part in a wide range of colours.

In particular embodiments, the invention can further comprise one or more of the following features, taken separately or in any technically possible combination.

In particular embodiments, voltages V1 and V2 are comprised between 1 and 150 volts and are applied for 1 to 10 minutes, or even between 2 and 5 minutes.

In particular embodiments, the first interference layer has a maximum thickness of 200 nm and the second interference layer has a minimum thickness of 1 nm.

In particular embodiments, machining is carried out so as to generate a material removal gradient in the plane in which the decorative face extends.

In particular embodiments, after the step of forming the second interference layer of titanium oxide, an additional step of machining a portion of the first interference layer and/or a portion of the second interference layer is carried out so as to form at least one additional opening leading to a portion of the decorative face, followed by a step of forming an additional interference layer by anodisation at a voltage V3 lower than voltage V2.

According to another aspect, the present invention relates to an external part for horology, jewellery or fashion accessories comprising a titanium substrate with a decorative face with a first interference layer of titanium oxide extending over a first portion of the decorative face, and a second interference layer of titanium oxide extending over a second portion of the decorative face, the first interference layer and the second interference layer being contiguous and each having a different thickness.

### BRIEF DESCRIPTION OF THE FIGURES

Other features and advantages of the invention will become apparent from the following detailed description, given by way of non-limiting example, with reference to the drawings in which:

FIGS. 1 to 3 schematically show successive steps involved in carrying out the decoration method according to an exemplary embodiment of the invention,

FIG. 4 shows a front view of an external part decorated using the method shown in steps 1 to 3,

FIGS. 5 and 6 schematically show additional steps according to another exemplary embodiment of the decoration method according to the invention, after the steps shown in FIGS. 1 to 3,

FIG. 7 schematically shows a front view of an external part decorated using the method shown in steps 1 to 3, 5 and 6.

It should be noted that the figures are not drawn to scale for clarity reasons.

### DETAILED DESCRIPTION OF THE INVENTION

One aspect of the present invention relates to an external part 10 for horology, jewellery or fashion accessories comprising a titanium substrate 100 with a decorative face 101. A first interference layer 110 of titanium oxide extends over a first portion of the decorative face 101, and a second interference layer 120 of titanium oxide extends over a second portion of said face.

Advantageously, the first interference layer 110 and the second interference layer 120 are contiguous and each has a different thickness, so that the decorative face 101 has two different interference colours.

The present invention also relates to a method for decorating such an external part 10 to obtain the aforementioned interference colours.

Preferentially, and as shown in FIGS. 3, 4 and 6, 7 in exemplary embodiments of the invention, the external part 10 is a watch dial and therefore has a disc-shaped body. Preferentially, the body of the external part is made entirely of titanium and forms the substrate 100. Alternatively, the body can have a layer of titanium several tenths of a millimetre or several millimetres thick forming the substrate 100.

In this document, the term “titanium” refers to pure titanium and titanium alloys.

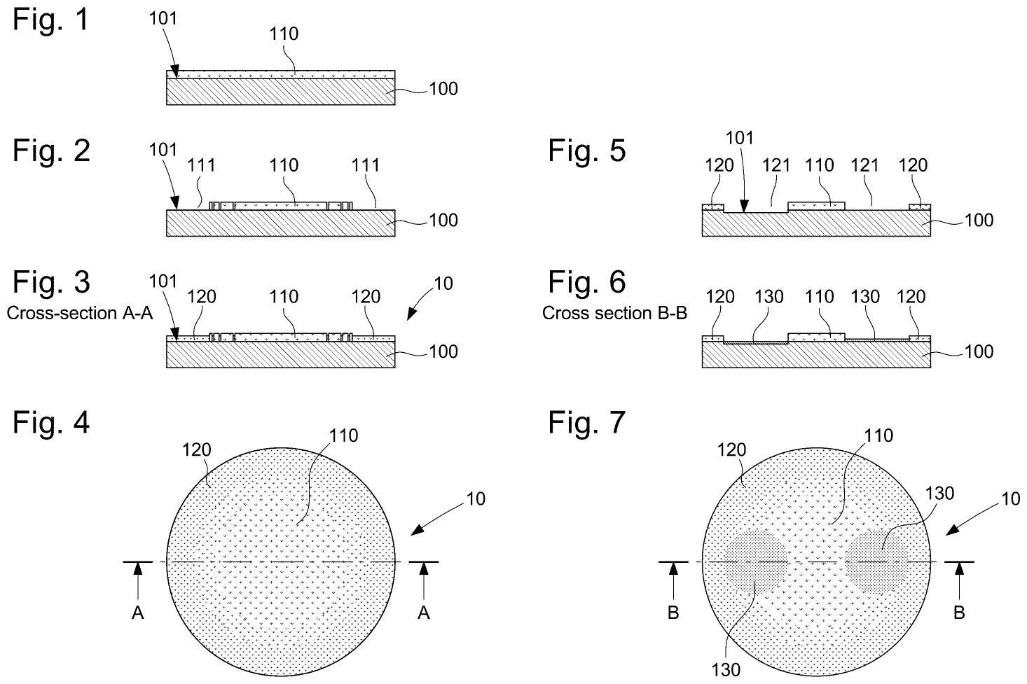

The method according to the invention comprises a step of forming the first interference layer 110 of titanium oxide on the entire decorative face 101 of the substrate 100, by anodising said decorative face 101 at a voltage V1. This step is schematically shown in FIG. 1.

Anodisation is carried out, in a manner known per se to the person skilled in the art, in an acidic or basic electrolytic bath, at a constant, regulated temperature, by applying an electric current and a predefined electrical voltage.

The bath can be composed of sulphuric, phosphoric or oxalic acid, or a mixture of these acids. Alternatively, the bath can be composed of sodium silicates, potassium hydroxide, sodium hydroxide or a mixture of these alkaline solutions. The concentrations of the acid or acids or of the basic solution or solutions in the electrolytic bath can be achieved by the person skilled in the art.

A step of machining a portion of the first interference layer 110 is then carried out so as to form at least one opening 111 leading to a portion of the decorative face 101. Machining is therefore carried out through the entire thickness of the first interference layer 110, as can be seen in FIG. 2. In other words, machining can be carried out so as to remove only the first interference layer 110 or to remove the first interference layer 110 and part of the substrate 100, thereby hollowing out a pocket in said substrate 100.

It should be noted that, in this document, the term “machining” refers to any operation involving the removal of material.

Such a machining step can therefore be carried out by any suitable material removal technique, for example, by laser machining, in particular by selective laser ablation, by mechanical machining, in particular with cutting tools or by sandblasting, by chemical machining or by photolithography.

The second interference layer 120 of titanium oxide is then formed on the portion of the decorative face 101 exposed in the machining step, by anodisation at a voltage V2 lower than voltage V1, as can be seen in FIG. 3.

The second interference layer 120 is therefore thinner than the first interference layer 110, and consequently the first and second interference layers 110 and 120 are differently coloured. The interference phenomenon is well-known as such to the person skilled in the art, and is therefore not described in this document.

Advantageously, the thickness of the first interference layer 110 does not vary when the second interference layer 120 is formed, as long as voltage V2 is lower than voltage V1.

The decoration created by the combination of the first interference layer 110 and of the second interference layer 120 is therefore defined by the pattern in which the first interference layer 110 is machined. This makes it easy to create rich, varied decorations in at least two different colours. By way of an exemplary embodiment, the first interference layer 110 can be machined using a material removal gradient, as schematically shown in FIGS. 2 and 3, so as to generate a colour gradient, as schematically shown in FIGS. 4 and 7.

More specifically, the material removal gradient is created in the plane in which the decorative face extends and is characterised by a change in the presence of the material of the first interference layer 110 on the decorative face 101 in one or more given directions. In particular, in FIGS. 4 and 7, the material gradient extends radially, with the material of the first interference layer 110 completely covering the decorative face at the centre of the external part 10, then covering less and less of the surface of the decorative face 101 as it moves further away from the centre of the external part 10. As the second interference layer 120 is formed on the portion of the decorative face 101 exposed in the machining step, its distribution over the decorative face inversely corresponds to that of the first layer 110. The junction between these two layers has a melted appearance, and consequently the colours of the first interference layer 110 and of the second interference layer 120 have a graduated appearance.

This type of machining can be carried out using a laser, sandblasting, sunray brushing, grinding or any other material removal technique previously referred to in the document.

By way of example, the voltages V1 and V2 applied when forming the first interference layer 110 and the second interference layer 120 are comprised between 1 and 150 volts, and are applied for 1 to 10 minutes, or even between 2 and 5 minutes.

The voltage values applied to the first interference layer 110 and the second interference layer 120 are determined according to the type of electrolytic bath and according to the desired colour of each of these layers.

By way of example, the first interference layer 110 can have a maximum thickness of 200 nm and the second interference layer 120 can have a minimum thickness of 1 nm. By way of example, the second interference layer 120 is 5 nm thinner than the first interference layer 110.

It should be noted that the parameters that make it possible to change the thickness of the interference layers formed by anodisation are the value of the applied voltage and the composition of the electrolytic chemical bath. It is therefore necessary to vary at least one of these parameters to obtain an interference layer with a desired thickness, so that it has a desired colour.

In particular, one of the interference layers can be produced by applying a voltage of 50 volts for 3 minutes during anodisation in an acid electrolytic bath, for example a 200 g/L sulphuric acid bath. The resulting layer is approximately 80 nm thick and light blue in colour.

Alternatively, one of the interference layers can be produced by applying a voltage of 40 volts for 3 minutes during anodisation in an acid electrolytic bath, for example a 200 g/L sulphuric acid bath. The resulting layer is approximately 60 nm thick and blue in colour.

In yet another example, one of the interference layers can be produced by applying a voltage of 20 volts for 3 minutes during anodisation in an acid electrolytic bath, for example a 200 g/L sulphuric acid bath. The resulting layer is approximately 35 nm thick and purple in colour.

In exemplary embodiments of the present invention, after the step of forming the second interference layer 120 of titanium oxide, the method can comprise an additional step of machining a portion of the first interference layer 110 and/or of a portion of the second interference layer 120. This additional machining step is carried out so as to form at least one additional opening 121 leading to a portion of the decorative face 101, as shown in FIG. 5. Machining can be carried out such that it extends only through the first interference layer 110 and/or the second interference layer 120, or so that it also extends into part of the substrate 100, thereby hollowing out a pocket in said substrate 100, as can be seen in FIG. 5. The additional machining step can be carried out so as to generate a material removal gradient in the plane in which the decorative face 101 extends, for example in addition to any gradient formed during the step of machining a portion of the first interference layer 110.

As illustrated in FIG. 6, this additional machining step is followed by a step of forming an additional interference layer 130 by anodisation at a voltage V3 lower than voltage V2. The external part 10 can thus be decorated such that it has three colours.

Of course, the method according to the invention can include as many machining steps followed by steps of forming an interference layer as desired, it being understood that the anodisation voltage of a layer must be lower than the voltage applied to form the previous layer. Given the foregoing, it is clear that each machining step can be carried out or not so as to generate a material removal gradient in the plane in which the decorative face 101 extends.

In addition, once the interference layers have been formed, they can be protected by a transparent protective layer applied, for example, by a vacuum deposition method, such as physical vapour phase deposition or chemical vapour phase deposition. The protective layer can alternatively be a layer of varnish, for example a cellulose-based varnish such as zapon, an acrylic or epoxy varnish, for example with a thickness comprised between 3 and 20 μm, or can be a layer of lacquer with a thickness comprised between 100 and 500 μm.

More generally, it should be noted that the variant embodiments considered above have been described by way of non-limiting examples, and that other variants are therefore conceivable.

Naturally, the method can comprise a preliminary step, in other words prior to the step of forming a first interference layer 110, consisting of preparing the decorative face 101 by conventional surface structuring methods, such as côte de Geneve, sunray brushing, sandblasting, polishing, etc.

1. A method for decorating an external part (10) for horology, jewellery or fashion accessories, characterised in that it comprises the steps of:
forming a first interference (110) layer of titanium oxide over the entire decorative face (101) of a titanium substrate (100) by anodising said decorative face (101) at a voltage V1,
machining a portion of the first interference layer (110) so as to form at least one opening (111) leading to a portion of the decorative face (101), the machining being carried out so as to generate a material removal gradient in the plane in which the decorative face extends,
forming a second interference layer (120) of titanium oxide by anodising said portion at a voltage V2 lower than voltage V1.

2. The method according to claim 1, in which voltages V1 and V2 are comprised between 1 and 150 volts and are applied for 1 to 10 minutes.

3. The method according to claim 1, in which the first interference layer (110) has a maximum thickness of 200 nm and the second interference layer (120) has a minimum thickness of 1 nm.

4. The method according to claim 1, in which, after the step of forming the second interference layer (120) of titanium oxide, an additional step of machining a portion of the first interference layer (110) and/or a portion of the second interference layer (120) is carried out so as to form at least one additional opening (121) leading to a portion of the decorative face (101), followed by a step of forming an additional interference layer (130) by anodisation at a voltage V3 lower than voltage V2.

5. An external part (10) for horology, jewellery or fashion accessories comprising a titanium substrate (100) with a decorative face (101) with a first interference layer (110) of titanium oxide extending over a first portion of the decorative face, and a second interference layer (120) of titanium oxide extending over a second portion of the decorative face, the first interference layer (110) and the second interference layer (120) being contiguous and each having a different thickness.
